(19) United States
(12) Patent Application Publication
(10) Pub. No.: US 2022/0178611 A1
(43) Pub. Date: Jun. 9, 2022

(54) Terpene Extraction System and Method

(71) Applicant: Marion Process Solutions, Inc., Marion, IA (US)

(72) Inventor: Jay Bonefas, Marion, IA (US)

(73) Assignee: Marion Process Solutions, Inc.

(21) Appl. No.: 17/115,339

(22) Filed: Dec. 8, 2020

(51) Int. Cl. F26B 5/04; B01D 8/00; B01F 7/04; H05B 6/80

(52) U.S. Cl. CPC F26B 5/048; H05B 6/802; B01F 7/04; B01D 8/00

(57) ABSTRACT

A terpene extraction system and method for efficiently extracting valuable terpenes from biological material, such as hemp. The terpene extraction system and method generally includes a fluid-bed mixer having a vessel, wherein the vessel can hold a vacuum and contain microwaves such that microwaves and vacuum can be applied to biological material in the vessel. The system also may include a microwave generator adapted to provide microwave radiation to the vessel, and one or more paddles adapted to move within the vessel, such that the paddle can agitate the biological material in the vessel and create a fluid bed. The system also includes a cold trap assembly in fluid communication with the vessel; and a vacuum pump in fluid communication with the vessel and the cold trap assembly, such that the vacuum pump can create a vacuum in the vessel by drawing vapor through the cold trap assembly.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND

### Field

Example embodiments in general relate to a terpene extraction system and method for extracting valuable terpenes from biological material.

### Related Art

Any discussion of the related art throughout the specification should in no way be considered as an admission that such related art is widely known or forms part of common general knowledge in the field.

In the past, solvents and physical methods (crushing) or distillation have been used to extract natural products from biological material. Subjecting the biological material to microwaves has also been done. However, many previous techniques, including those using microwaves, do not provide for uniform heating of bulk materials, and are not suitable for scaling to larger systems and batch sizes.

### SUMMARY

An example embodiment is directed to a terpene extraction system and method. The terpene extraction system includes a fluid-bed mixer, comprising a vessel, wherein the vessel can be sealed and can hold a vacuum and contain microwaves such that microwaves and vacuum can be applied to a biological material in the vessel. The system may also include a microwave generator adapted to provide microwave radiation to the vessel, and a paddle (or multiple paddles) adapted to move within the vessel, such that the paddle can agitate the biological material in the vessel and create a fluid bed.

The system can also include a cold trap assembly in fluid communication with the vessel and a vacuum pump in fluid communication with the vessel and the cold trap assembly, such that the vacuum pump can create a vacuum in the vessel by drawing vapor through the cold trap assembly. The cold trap assembly may comprise or include a plurality of cold traps with collectors connected in series between the vessel and the vacuum pump. The cold trap collectors can be immersed in or surrounded by a liquid at a very low temperature, to condense vapor into liquid in the collectors.

The terpene extraction system may further comprise one or more temperature sensors adapted to sense temperature of the biological material in the vessel, or to sense the temperature of the inside of the vessel itself. The system may also include one or more pressure sensors in order to control the pressure of the vessel, which has proven to be advantageous—specifically, when a vacuum is applied and maintained in the vessel containing biological material being processed.

Use of the system may comprise a method, having or including the steps of placing terpene-rich biological material in the vessel, sealing the vessel, rotating the paddle or paddles within the vessel (such that a fluid bed is created). Further, microwave radiation can be applied to the vessel. During the process, a process temperature is typically controlled at a target temperature for terpene extraction by controlling the application of microwave radiation (such as by selectively applying and removing the radiation). Further steps may include applying a vacuum to the vessel with the vacuum pump such that vapor is drawn out of the vessel and through the cold trap assembly, and draining condensate containing terpenes from the cold trap assembly, specifically, by draining the collectors if more than one cold trap is used.

The method may also include the step of setting a condenser temperature of the cold trap assembly. In some example embodiments, the paddle may comprise multiple horizontal paddles mounted on a rotating shaft within the vessel. The system may also include a pressure sensor adapted for use in controlling a pressure or vacuum level in the vessel.

The method may further comprise controlling the process pressure such that the target pressure repeatedly cycles between at least two pressures. For example, good results have been achieved by repeatedly cycling the pressure in the vessel between 200 and 700 torr while applying heat and agitation. Good results have also been achieved by controlling the target temperature between 150° F. and 200° F. during the extraction process.

There has thus been outlined, rather broadly, some of the embodiments of the terpene extraction system and method in order that the detailed description thereof may be better understood, and in order that the present contribution to the art may be better appreciated. There are additional embodiments of the terpene extraction system and method that will be described hereinafter and that will form the subject matter of the claims appended hereto. In this respect, before explaining at least one embodiment of the terpene extraction system and method in detail, it is to be understood that the terpene extraction system and method is not limited in its application to the details of construction or to the arrangements of the components set forth in the following description or illustrated in the drawings. The terpene extraction system and method is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a perspective view of a fluid bed mixer in accordance with an example embodiment.

FIG. 2 is a perspective view of a terpene extraction system in accordance with an example embodiment.

FIG. 3 is a detail view of a terpene extraction system in accordance with an example embodiment.

FIG. 4 is a functional diagram of a terpene extraction system in accordance with an example embodiment.

FIG. 5 is a flow chart of a method of terpene extraction in accordance with an example embodiment.

### DETAILED DESCRIPTION

### A. Overview.

An example terpene extraction system generally comprises a fluid-bed mixer 10 having a vessel 18, wherein the vessel 18 can be sealed and can hold a vacuum and contain microwaves such that microwaves and vacuum can be applied to a biological material 11 in the vessel 18. The system may also include a microwave generator 17 adapted to provide microwave radiation to the vessel 18, and a paddle 15 (or multiple paddles) adapted to move within the vessel 18, such that the paddle 15 can agitate the biological material 11 in the vessel and create a fluid bed.

The system can also include a cold trap assembly 30 in fluid communication with the vessel and a vacuum pump 50 in fluid communication with the vessel 18 and the cold trap assembly 30, such that the vacuum pump 50 can create a vacuum in the vessel 18 by drawing vapor through the cold trap assembly 30. The cold trap assembly may comprise or include a plurality of cold traps 32, 34, 36 with collectors, connected in series between the vessel 18 and the vacuum pump 50. The cold trap collectors can be immersed in or surrounded by a liquid at a very low temperature, to condense vapor into liquid in the collectors.

The terpene extraction system may further comprise one or more temperature sensors 20 adapted to sense temperature of the biological material in the vessel, or to sense the temperature of the inside of the vessel itself. The system may further include one or more pressure sensors 22 to sense and control the process pressure of the vessel 18.

### B. Fluid Bed Mixer.

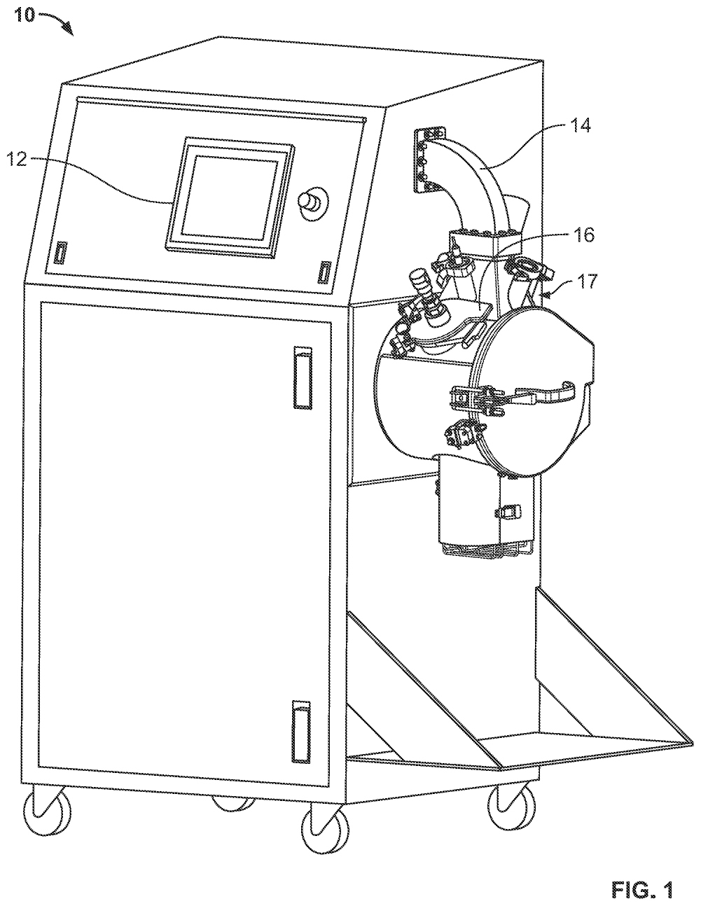

As noted above, the terpene extraction system may include a fluid bed mixer 10, such as a horizontal paddle mixer having a sealable vessel 18 with motor driven, horizontal paddles 15. Although one particular model and size fluid bed mixer is shown, for example in FIGS. 1-3, other sizes, models, and configurations are also possible. More particularly, larger models can be used to scale the extraction process for terpene extraction from large batches of biological materials, such as hemp. By way of a non-limiting example, a larger fluid bed mixer may be used, such as that shown and described in U.S. patent application Ser. No. 16/550,926, filed on Aug. 26, 2019, and titled “Plant Drying System,” which is hereby incorporated by reference.

The fluid bed mixer 10 generally comprises a vessel 18 having an inlet 16 for receiving a volume of a plant material 11, a microwave generator 17 for applying microwave energy to the plant material 11 via a microwave guide 14. The mixer 10 may also include one or more temperature sensors 20 and one or more pressure sensors 22 for detecting a temperature of the plant material 11 within the vessel, and the pressure within the vessel. The fluid bed mixer 10 may further include an interface 12 for setting up the system and method for efficient extraction—for example, the interface 12 may be used to set temperatures, pressures, operating time, etc., and may also be used to turn on the fluid bed mixer, such as by starting the agitation by paddles 15. The mixer may include a control unit that is capable of automatically adjusting a level of microwave energy applied to the plant material 11 so as to maintain the temperature of the plant material 11 within a desired temperature range, the control unit may also be used to control process pressure, and to determine a moisture level of the plant material 11 within the vessel.

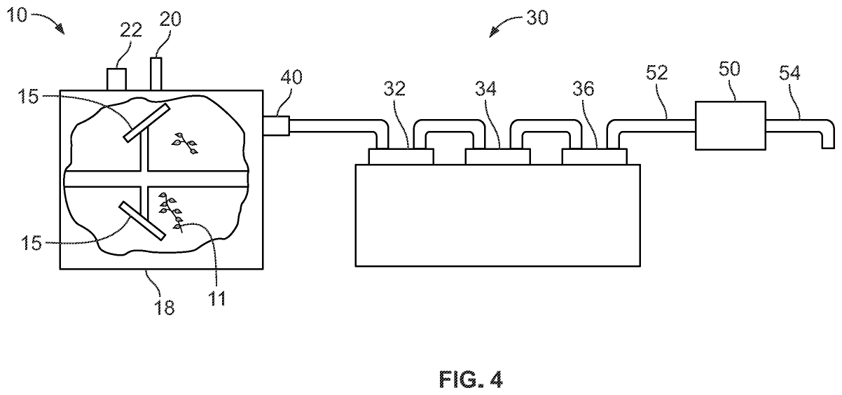

As best shown in FIG. 4, the vessel 18 may have within it an agitator comprising a shaft and attached agitator paddles 15, which serve to agitate any product within the vessel 18, which in turn aids in drying the biological material 11 and causing terpenes to vaporize, and distributing heat and energy uniformly, to avoid overprocessing some material and under processing other material. Although the paddles 15 are shown on a generally horizontal shaft, other configurations are possible.

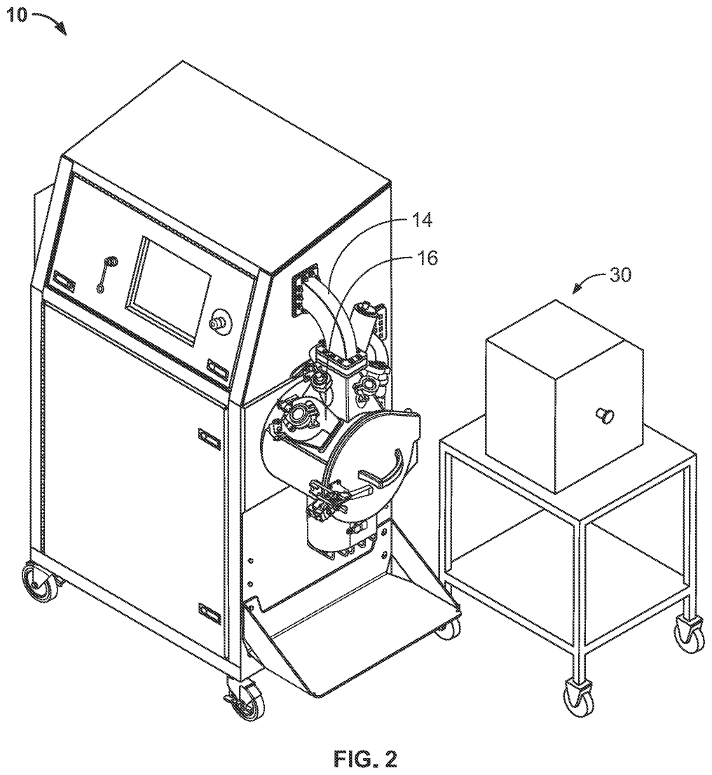

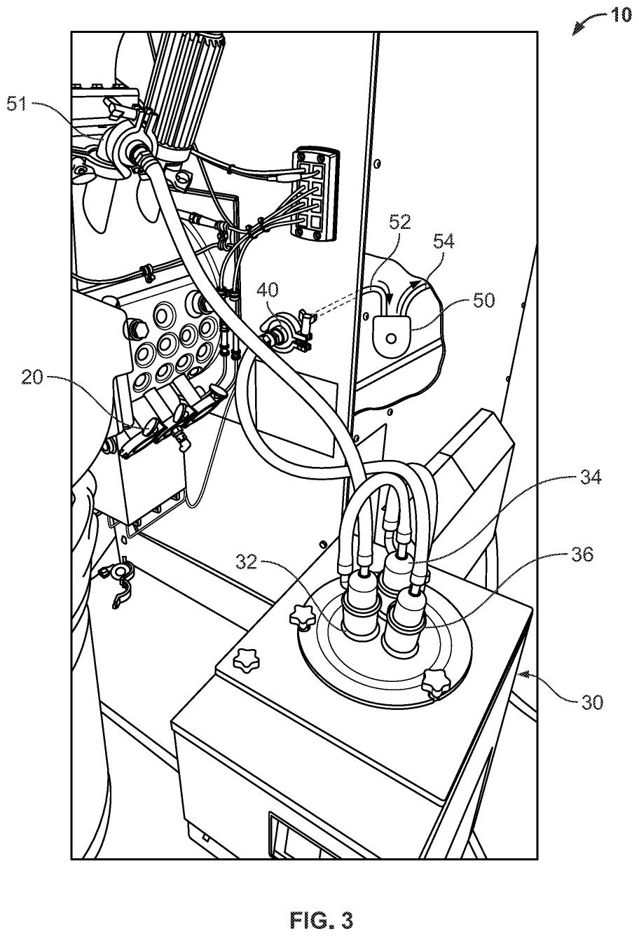

As shown in FIG. 1, the fluid bed mixer 10 also includes a vacuum pump 50 that is in fluid communication with the vessel 18 via cold trap connection 51. The cold trap assembly 30 is in fluid communication with, and connected in series between the vessel 18 and the vacuum pump 50, as shown in FIGS. 3 and 4. When the vacuum pump is on, it creates a vacuum within vessel 18, and any terpenes that are released from the biological material 11 within the vessel 18 will be drawn by the vacuum pump 50 through the cold trap assembly 30 (shown in FIGS. 3 and 4, and in isolation in FIG. 2 next to fluid bed mixer 10). The final cold trap 36 in the series is connected to the vacuum pump through connection 40 and vacuum inlet line 52, and the vacuum pump 50 discharges through vacuum drain line 54.

The fluid bed mixer 10 may also include a control unit to control the system, via interface 12. The control unit may be comprised of any conventional computer, or it may also be a programmable logic controller (PLC). A PLC lends itself naturally to this application because it is relatively easy to program and has outputs that can be used to control the plant drying system, such as for valve control, microwave power control, temperature and pressure measurement and control, etc. A PLC may also readily accept any inputs that are needed for the plant drying system, such as inputs from temperature sensor 20 and pressure sensor 22, as shown in FIGS. 3-4.

### C. Cold Trap Assembly.

As shown in FIGS. 3 and 4, the terpene extraction system may include a cold trap assembly 30. The assembly may further comprise multiple individual cold traps connected in series, such as a first cold trap 32, a second cold trap 34, and a third cold trap 36. More or fewer cold traps are also possible. As best shown in FIG. 4, when vacuum pump 50 is on, it draws vapors out of the vessel 18 via connection 40. The vapor will contain any terpenes released from the biological material 11, such as hemp. The vapor will be drawn through each cold trap, and with multiple individual cold traps, more material (e.g., terpenes) may be extracted. The cold trap assembly 30 may have its own temperature control, and may be activated at the beginning of the extraction process. The cold trap assembly 30 may contain a chilled liquid in which the collector of each individual cold trap 32, 34, 36 is immersed, such that terpenes will condense in the collectors as vapor is drawn out of the vessel by vacuum pump 50.

As is known, a cold trap is a device that condenses all vapors except permanent gases into a liquid or solid. Cold traps are commonly used to prevent unwanted vapors from entering a vacuum pump and contaminating or damaging it, but in this case the cold traps are used to recover condensate which contains desirable terpenes.

### D. Operation of Preferred Embodiment.

The system and method can be used to extract valuable terpenes or other natural products from biological material, such as hemp, without solvents or crushing, for example.

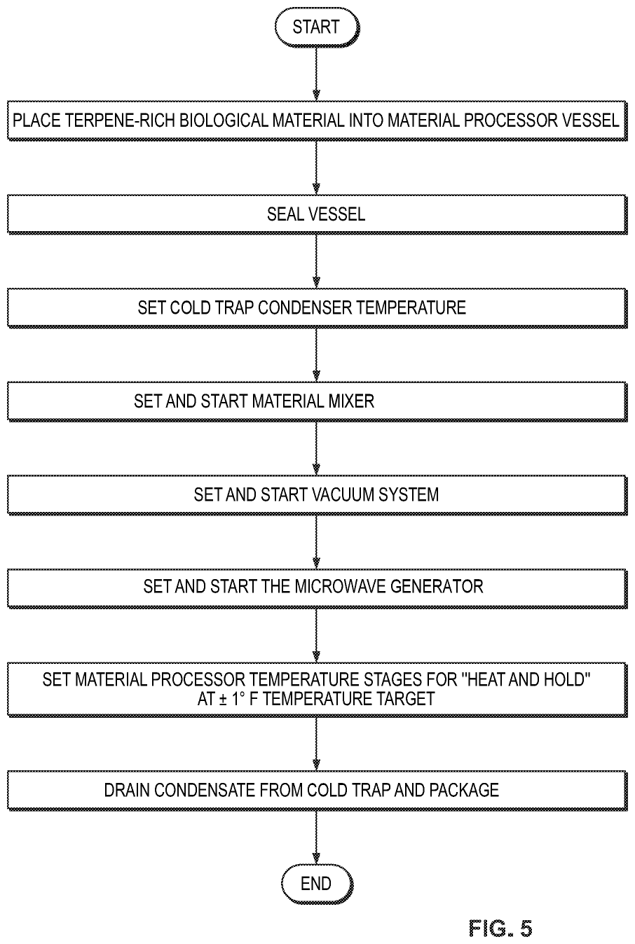

In use, the general process outlined in FIG. 5 may be applied. To start the process, terpene-rich biological material 11, such as hemp, is placed in the vessel 18, after which the vessel 18 is sealed so that a vacuum may be applied, as well as microwave radiation. Next, the temperature of the cold trap assembly 30 (e.g., terpene trap) is set. The cold trap assembly 30 may comprise mechanical refrigeration to achieve temperatures low enough for proper operation of the extraction system. As mentioned above, the cold trap temperature should be low enough to condense the desired terpenes. Next, the material processing agitation (fluid bed mixer) is started after other process settings, such as temperature, pressure, etc., have been made. When the fluid bed mixer 10 is started, the paddles 15 will rotate within the vessel 18 and create a fluid bed of any material in the vessel, which in turn creates even and efficient heating of the material, better than what can be achieved with microwaves alone.

Generally, the optimal settings for terpene extraction will include setting a target temperature and pressure, which are controlled by monitoring the temperature sensor 20 and pressure sensor 22 and operating the microwave generator 17 and the vacuum pump 50 to maintain the desired parameters. During the process, the desired process temperature is typically controlled at a target temperature for terpene extraction by controlling the application of microwave radiation (such as by selectively applying and removing the radiation), e.g., by controlling the microwave generator 17. The microwave generator 17 delivers microwave energy to the vessel 18 via microwave guide 14, as shown in FIGS. 1-2. The microwave generator 17 generates microwave energy generally in one of two different frequencies applicable for industrial use: 915 MHz or 2450 MHz, although other frequencies are possible. As a result of the energy, water evaporates from biological material 11. Temperature control of the bulk biological material 11 is very accurate with this system, and can be held to +1° F. due to temperature control sensors in the fluid bed or in the interior of vessel 18 in any of various locations.

Further steps may include using the vacuum pump 50 to apply a vacuum to the vessel 18, such that vapor containing terpenes is drawn out of the vessel 18 and through the cold trap assembly 30. This vacuum/exhaust stream is directed through the cold trap assembly 30 to condense the vapor, including the valuable terpenes, for collection. Once the process is finished, the method includes draining condensate containing terpenes from the cold trap assembly 30, specifically, by draining the individual cold trap collectors if more than one cold trap is used.

As an example, a target temperature of between about 150° F. and 200° F. may be used, and the system (e.g., with manual control or with an automatic control unit) is capable of maintaining a set target temperature within about +1° F. in a “heat and hold” mode of operation. The target temperature may be adjusted depending on what terpenes are desired to be extracted, as different compounds may be released from the biological material at different temperatures. In addition, maintaining a target pressure or vacuum can increase efficiency of terpene extraction. However, rather than controlling the process at a single, constant pressure or vacuum, it has been found to be advantageous to cycle the vacuum pump 50 between pressure set points. As an example, the target pressure (or vacuum) may be repeatedly cycled between 200 and 700 torr while a target temperature is maintained and the extraction process continues.

The method may further comprise controlling the vacuum pump 50 such that the target pressure repeatedly cycles between at least two pressures. For example, good results have been achieved by repeatedly cycling the pressure in the vessel between 200 and 700 torr while applying heat and agitation. Good results have also been achieved by controlling the target temperature between 150° F. and 200° F. during the extraction process.

The PLC or other control unit may include an interface 12 to provide users with the capability to program and use the system, and to serve as an interface with the control unit (not shown). Various inputs and outputs as discussed herein are used by the control unit to carry out the steps described herein, although some or all steps may also be performed manually.

Unless otherwise defined, all technical and scientific terms used herein have the same meaning as commonly understood by one of ordinary skill in the art to which this invention belongs. Although methods and materials similar to or equivalent to those described herein can be used in the practice or testing of the terpene extraction system and method, suitable methods and materials are described above. All publications, patent applications, patents, and other references mentioned herein are incorporated by reference in their entirety to the extent allowed by applicable law and regulations. The terpene extraction system and method may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A terpene extraction system, comprising:
a fluid-bed mixer, comprising a vessel, wherein the vessel can hold a vacuum and contain microwaves such that microwaves and vacuum can be applied to a biological material in the vessel;
a microwave generator adapted to provide microwave radiation to the vessel;
a paddle adapted to move within the vessel, such that the paddle can agitate the biological material in the vessel and create a fluid bed;
a cold trap assembly in fluid communication with the vessel; and
a vacuum pump in fluid communication with the vessel and the cold trap assembly, such that the vacuum pump can create a vacuum in the vessel by drawing vapor through the cold trap assembly.

2. The terpene extraction system of claim 1, wherein the cold trap assembly comprises a plurality of cold traps connected in series between the vessel and the vacuum pump.

3. The terpene extraction system of claim 1, further comprising a temperature sensor adapted to sense a temperature of the biological material in the vessel.

4. A method of using the terpene extraction system of claim 3, comprising:
placing the biological material in the vessel;
sealing the vessel;
rotating the paddle;
applying microwave radiation to the vessel;
controlling a process temperature at a target temperature for terpene extraction by controlling an application of microwave radiation;
applying a vacuum to the vessel with the vacuum pump such that vapor is drawn out of the vessel and through the cold trap assembly; and
draining condensate containing terpenes from the cold trap assembly.

5. The method of claim 4, further comprising the step of setting a condenser temperature of the cold trap assembly.

6. The terpene extraction system of claim 1, wherein the paddle comprises multiple horizontal paddles.

7. The terpene extraction system of claim 1, further comprising a pressure sensor adapted for use in controlling a pressure in the vessel.

8. A method of using the terpene extraction system of claim 7, comprising:
placing the biological material in the vessel;
sealing the vessel;
rotating the paddle;
applying microwave radiation to the vessel;
controlling a process temperature at a target temperature for terpene extraction by controlling an application of microwave radiation;
applying a vacuum to the vessel with the vacuum pump such that vapor is drawn out of the vessel and through the cold trap assembly;
controlling a process pressure to a target pressure for terpene extraction by using the pressure sensor to control the vacuum pump; and
draining condensate containing terpenes from the cold trap assembly.

9. The method of claim 8, further comprising the step of setting a condenser temperature of the cold trap assembly.

10. The method of claim 8, further comprising controlling the process pressure such that the target pressure repeatedly cycles between at least two pressures.

11. The method of claim 10, wherein the process pressure repeatedly cycles between 200 and 700 torr.

12. The method of claim 8, wherein the target temperature is between 150° F. and 200° F.

13. A terpene extraction system, comprising:
a fluid-bed mixer, comprising a vessel, wherein the vessel can hold a vacuum and contain microwaves such that microwaves and vacuum can be applied to a biological material in the vessel;
a microwave generator adapted to provide microwave radiation to the vessel;
a plurality of paddles adapted to move within the vessel, such that the plurality of paddles can agitate the biological material in the vessel and create a fluid bed comprising the biological material;
a temperature sensor adapted to sense a temperature of the biological material in the vessel;
a vacuum pump in fluid communication with the vessel and the cold trap assembly, such that the vacuum pump can create a vacuum in the vessel;
a pressure sensor adapted for use in controlling a pressure in the vessel through selective activation of the vacuum pump; and
a cold trap assembly in fluid communication with the vessel, the cold trap assembly comprising a plurality of cold traps connected in series between the vessel and the vacuum pump, wherein the vacuum pump creates a vacuum in the vessel by drawing vapor through the cold trap assembly.

14. A method of using the terpene extraction system of claim 13, comprising:
placing the biological material in the vessel;
sealing the vessel;
rotating the paddle;
applying microwave radiation to the vessel;
controlling a process temperature at a target temperature for terpene extraction by controlling an application of microwave radiation;
applying a vacuum to the vessel with the vacuum pump such that vapor is drawn out of the vessel and through the cold trap assembly;
controlling a process pressure at a target pressure; and
draining condensate containing terpenes from the cold trap assembly.

15. The method of claim 14, further comprising the step of setting a condenser temperature of the cold trap assembly.

16. The method of claim 15, further comprising controlling the process pressure such that the target pressure repeatedly cycles between at least two pressures.

17. The method of claim 16, wherein the process pressure repeatedly cycles between 200 and 700 torr.

18. The method of claim 14, wherein the target temperature is between 150° F. and 200° F.
